(19) United States
(12) Patent Application Publication
(10) Pub. No.: US 2003/0043261 A1
(43) Pub. Date: Mar. 6, 2003

(54) Magnifying device for a panoramic anamorphic image capture system

(75) Inventors: Sajan Gianchandani, Paris (FR); Alexandre Leroy, Sannois (FR)

Correspondence Address: SCHNADER HARRISON SEGAL & LEWIS, LLP, 1600 MARKET STREET, SUITE 3600, PHILADELPHIA, PA, 19103

(73) Assignee: Egg Solution Optronics SA, Paris (FR)

(21) Appl. No.: 10/251,132

(22) Filed: Sep. 20, 2002

Related U.S. Application Data
(63) Continuation of application No. PCT/FR01/00879, filed on Mar. 22, 2001.

(30) Foreign Application Priority Data
Mar. 22, 2000 (FR) FR 00/03672
Sep. 20, 2000 PCT/FR00/02606

(51) Int. Cl. H04N 7/00

(52) U.S. Cl. 348/36

(57) ABSTRACT

A magnifying device for a panoramic anamorphic image capture system, the system having an optical axis A and a primary reflector provided with an at least partially reflective exterior primary capture surface, including at least one lens, at least a portion of which is a hollow tube, a principal axis P and a positive or negative enlargement essentially perpendicular to principal axis P.

### RELATED APPLICATION

This is a continuation of International Application No. PCT/FR01/00879, with an international filing date of Mar. 22, 2001, which is based on French Patent Application No. 00/03672, filed Mar. 22, 2000, and PCT/FR00/02606, with an international filing date of Sep. 9, 2002.

### FIELD OF THE INVENTION

This invention relates to capturing images by anamorphosis over 360°. The invention pertains more specifically to a magnifying device for a panoramic anamorphic image capture system, the system having an optical axis, as well as a primary reflector means equipped with an at least partially reflective exterior primary capture surface.

### BACKGROUND

Panoramic anamorphic image capture devices are known in the art. WO-A99/30197 pertains to an omnidirectional device for capturing the image of a scene from a single point of view. This device comprises an essentially parabolic reflector positioned to orthographically reflect the principal rays of electromagnetic radiation emitted by the scene. The reflector has a focal point which coincides with the single point of view of the omnidirectional device, including the essentially parabolic reflector means. The device also comprises one or more image sensors positioned to receive the orthographically reflected principal rays of the electromagnetic radiation from the parabolic reflector, which enables capturing the image of the scene.

The major drawback of the anamorphic image capture devices of the prior art is the fact that no means is provided to enable enlargement of the anamorphic image projected or captured over 360°.

It would accordingly be advantageous to resolve the drawback of the prior art by providing a device which not only enables enlargement or reduction of the image, but allows selection of exactly the desired enlargement or reduction and possibly to vary it.

### SUMMARY OF THE INVENTION

This invention relates to a magnifying device for a panoramic anamorphic image capture system, the system having an optical axis A and a primary reflector provided with an at least partially reflective exterior primary capture surface, including at least one lens, at least a portion of which is a hollow tube, a principal axis P and a positive or negative enlargement essentially perpendicular to principal axis P.

### BRIEF DESCRIPTION OF THE DRAWINGS

Better understanding of the invention will be obtained from the description below of a mode of implementation of the invention presented solely for explanatory purposes and with reference to the attached figures:

FIG. 1 is a perspective view of a portion of a hollow cylinder creating an enlargement device according to aspects of the invention;

FIG. 2 is a front view of the portion of a hollow cylinder of FIG. 1;

FIG. 3 is a perspective view of a hollow cylinder creating an enlargement device according to aspects of the invention;

FIG. 4 illustrates the visual field of a capture system equipped with an enlargement device according to aspects of the invention;

FIG. 5 is a sectional view of a protective housing of a capture system equipped with an enlargement device according to aspects of the invention;

FIG. 6 illustrates a version of the invention in which the capture system has a primary reflector and a secondary reflector arranged back to back;

FIG. 7 illustrates a version of the invention in which the capture system has a primary reflector and a secondary reflector arranged face to face;

FIG. 8 illustrates a version of the invention in which the capture system has a primary reflector and a secondary reflector arranged back to back with the image capture device positioned between them; and

FIG. 9 illustrates a version of the invention in which the capture system has a primary reflector and a secondary reflector arranged face to face with the image capture device positioned between them.

### DETAILED DESCRIPTION

It will be appreciated that the following description is intended to refer to specific embodiments of the invention selected for illustration in the drawings and is not intended to define or limit the invention, other than in the appended claims.

In a broad sense, the magnifying device of the invention is constituted of at least one lens in the form of at least a portion of a hollow tube having a principal axis and an enlargement essentially perpendicular to this axis. The principal axis is preferably coincident with the optical axis of the panoramic anamorphic image capture system. The lens is preferably mounted so that it can move along its principal axis. The lens preferably has an exterior surface created by a generatrix which is essentially parabolic, comprises essentially an arc of a circle or is essentially elliptic or aspheric. The primary reflector surface is preferably constituted of a concave conical primary surface.

In a variant, the capture system comprises at least one at least partially reflective transmission surface and a secondary reflector provided with an at least partially reflective concave exterior secondary surface having the form of a cone and is essentially coaxial with the primary reflector. The lens(es) is (are) preferably located on a protective housing having at least one window.

The invention also pertains to a set of magnifying devices which is remarkable in that the magnifying devices have substantially identical general configurations making them interchangeable in relation to each other and of different enlargements.

The invention also pertains to an anamorphic capture system having an optical axis as well as an at least partially reflective capture system and comprising at least one enlargement device.

The invention further pertains to a panoramic anamorphic image capture process by means of a magnifying device according to the invention.

The invention, thus, advantageously facilitates focusing on a particular zone of the captured image by enabling a magnification of the image. This advantage finds applications especially in the domain of electronic surveillance by means of an anamorphic image capture device over 360°. The invention, thus, advantageously facilitates augmentation of the visual field by selection of a suitable negative enlargement. The invention can be applied notably to traditional or digital cameras, traditional or digital video cameras, electromagnetic wave or particle detectors, helmets, goggles and the like.

Turning now to the drawings generally, the device (100), according to aspects of the invention, is a magnifying device for a panoramic anamorphic image capture system (1). The system (1) has an optical axis A as well as a primary reflector (2) provided with an at least partially reflective exterior primary capture surface (3).

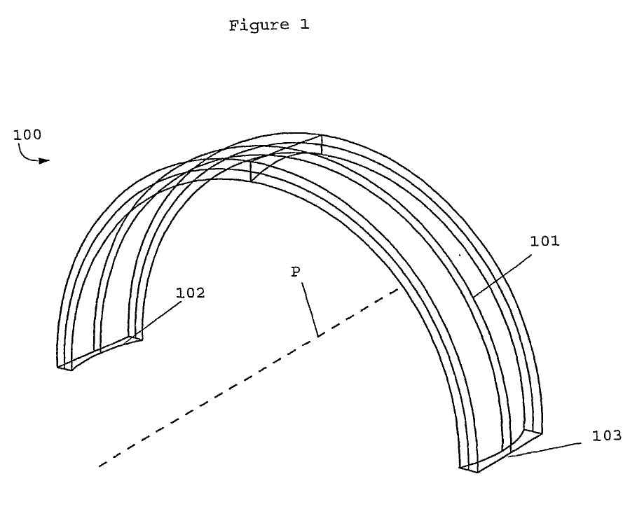

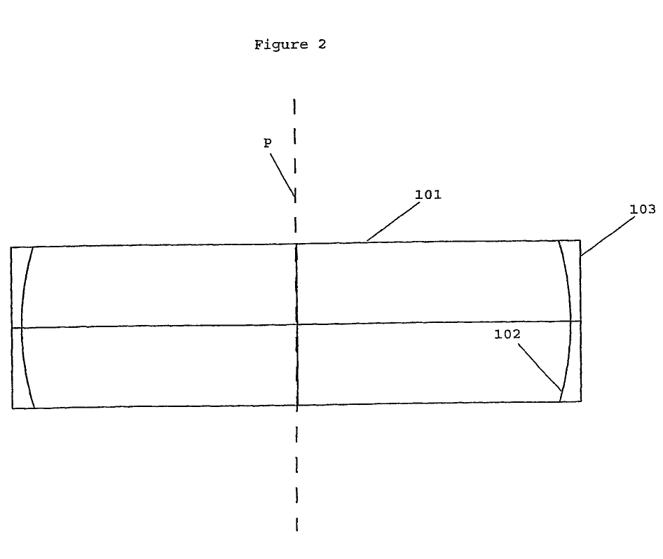

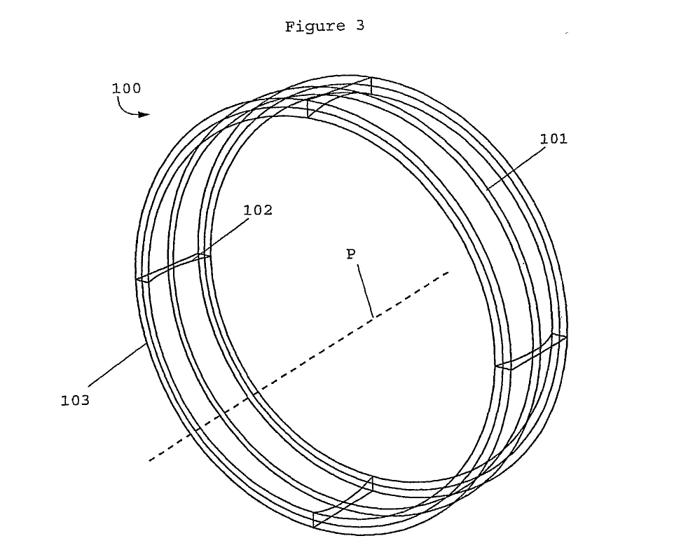

The device (100) comprises at least one lens (101, 111) in the form of at least a portion of a hollow tube having a principal axis P and a positive or negative enlargement essentially perpendicular to axis P, as illustrated in FIGS. 1 and 2. The lens (101, 111) can also have the form of a complete hollow tube as illustrated in FIG. 3 and thereby create a ring.

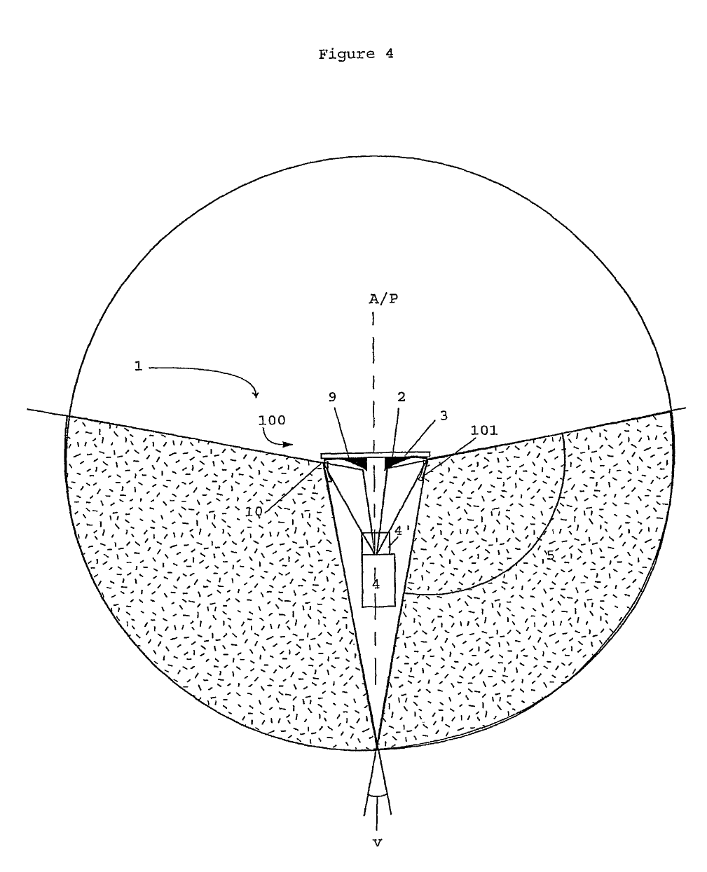

The lens (101, 111) is arranged such that the principal axis P is coincident with the optical axis A of the panoramic anamorphic image capture system (1), as illustrated in FIG. 4.

The panoramic anamorphic image capture system (1) comprises at least one primary reflector (2) provided with an at least partially reflective exterior primary surface (3) to enable reflection of images to at least one image capture device (4) such as a camera, video camera or the like.

The primary surface (3) preferably constitutes a mirror transmitting all of the waves, but it can possibly have a filter to prevent transmission or reflection of certain or selected waves. The primary reflector (2) is constituted of a concave conical primary surface (3), i.e., a surface curved inwardly towards the central axis.

According to selected variants of the invention, the conical surface is generated by an essentially parabolic generatrix or by a generatrix comprising essentially an arc of a circle or by an essentially elliptic generatrix, depending on the desired characteristics of the image. The section viewed from below is, thus, a circle or an ellipse. For example, the primary surface (3) can be a conical surface comprising an arc of a circle having a radius R of about 60 millimeters, for an angle P of about 56.5° and the exterior diameter I can be about 120 millimeters.

By means of the concave conical primary surface (3), the departure point of the angle of vision of the proximal end of the reflector is offset towards the distal end. Thus, the primary surface (3) does not reflect the image capture device or the optical system (4′) of the image capture device (4) because this device is now outside of the visual field (5) and the primary surface (3) can be placed in a protective device also located outside of the field of vision (5).

The primary reflector (2) can have the form of a cone, the vertex (6) of which is truncated and the system (1) can comprise an attachment means positioned at least at the level of the vertex (6) to enable attachment to the image capture device (4). This attachment element can be constituted, e.g., of a shaft positioned in the axis A of the optical system of the system (1) and fixed against the vertex (6).

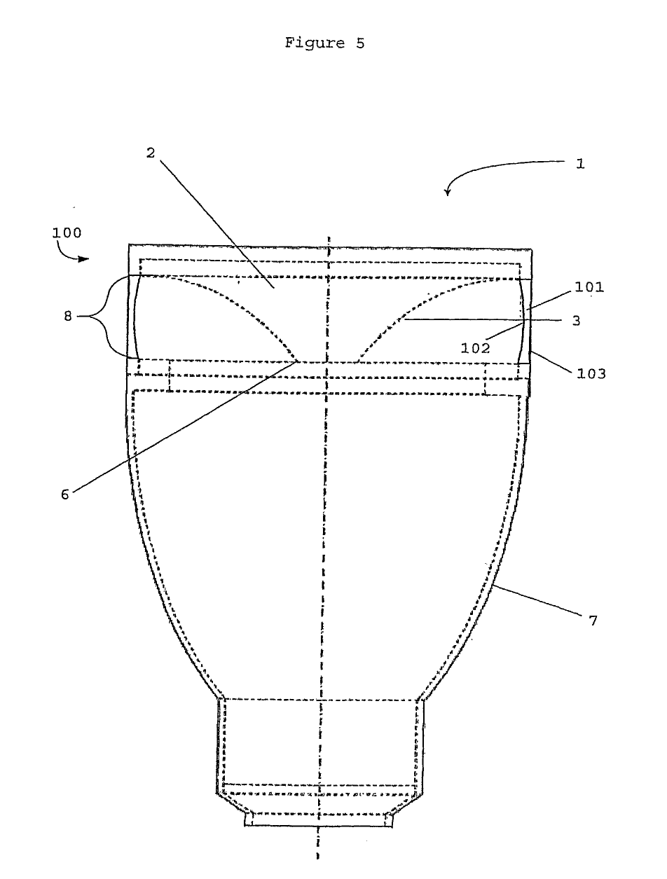

This attachment element can also be constituted, e.g., of a housing (7) comprising screw threads which cooperate with the screw threads usually provided at the end of the optical system (4′) of the image capture device (4), this housing also being fixed against the vertex (6) as illustrated in FIG. 5.

In this basic version, the primary reflector (2) is positioned in the axis of the optical system of the image capture device (4) either vertically or horizontally or possibly at an incline. The lens (101, 111), thus, also enables augmenting the visual field of the panoramic anamorphic image capture system (1).

In a preferred version, the lens (101, 111) is mounted so that it can move along its principal axis P to enable easy modification of the operating enlargement. The lens (101, 111) has an exterior surface (5) created according to the case by means of an essentially parabolic generatrix, a generatrix comprising essentially an arc of a circle or an essentially elliptic generatrix.

In a preferred version of the invention, the panoramic anamorphic image capture system (1) comprises at least one at least partially reflective transmission surface (11, 21) coaxial with the primary reflector (2) to enable inversion of the position of the image capture device (4) on the optical axis A.

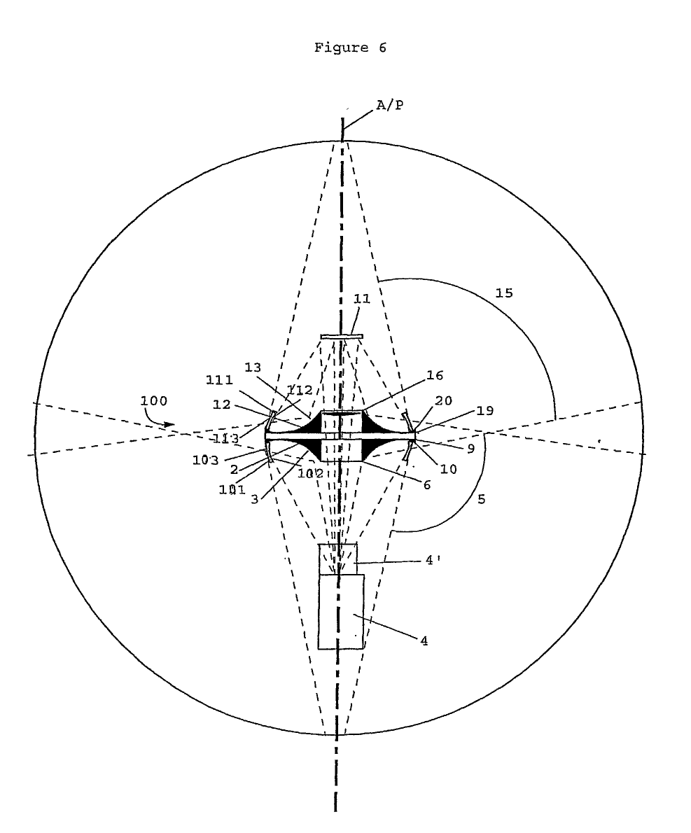

In this version, the system (1) comprises a secondary reflector (12) provided with an at least partially reflective exterior secondary surface (13) having a concave conical form and essentially coaxial with the primary reflector (2) and the secondary vertex (16) of which is truncated and hollow. The primary reflector (2) and the secondary reflector (12) can be identical and can be positioned symmetrically in relation to a plane substantially perpendicular to the optical axis A of the system (1). The primary reflector (2) and the secondary reflector (12) can be positioned back to back, i.e., base (9) against base (19) as illustrated in FIG. 6. In this version, a single lens (101) can be provided for the two reflecting devices.

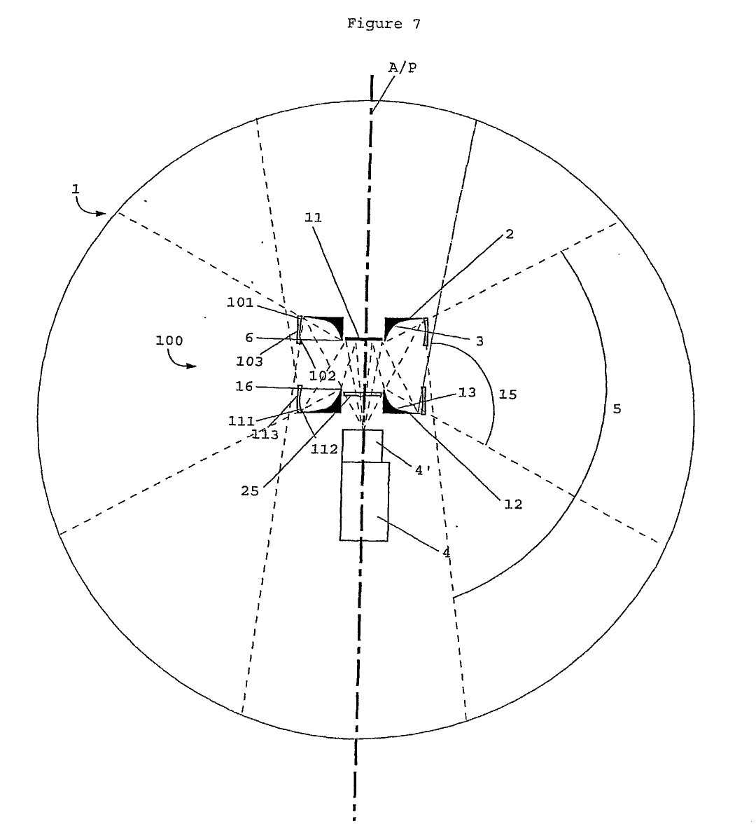

The primary reflector (2) and the secondary reflector (12) can be positioned face to face, i.e., primary surface (3) to secondary surface (13) as illustrated in FIG. 7. The transmitting surface (11) is then flat or possibly convex and the vertex (16) of the secondary reflector means (12) preferably comprises an at least partially transparent surface (25). In this version, each reflecting device has its own lens (101, 111).

In the two preceding versions, the image capture device (4) is positioned in the optical axis A of the system (1), but it can also be envisaged to position the image capture device (4) between the primary reflector (2) and the secondary reflector (12), essentially perpendicular to the optical axis A of the system (1).

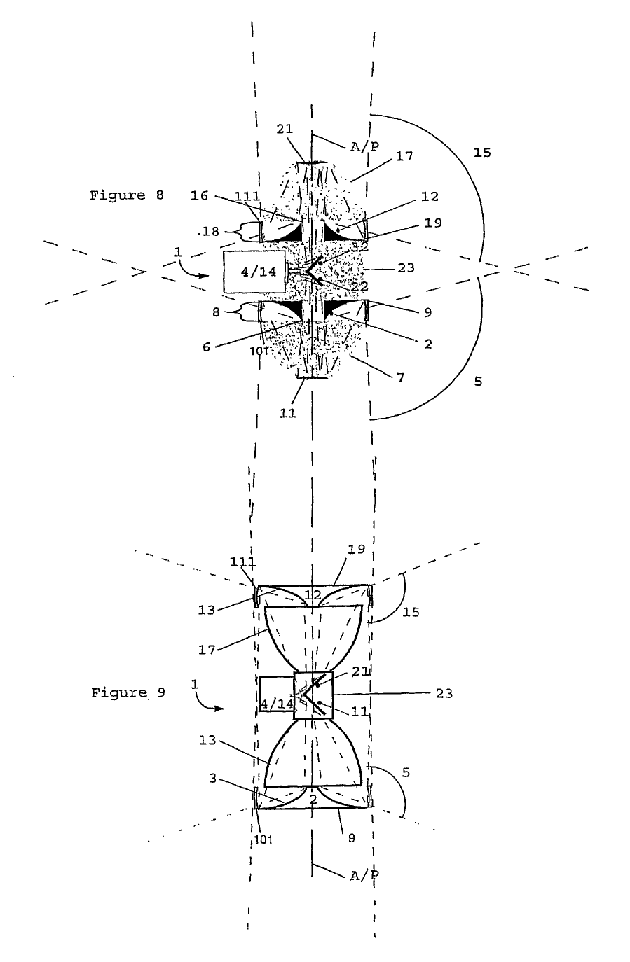

FIG. 8 illustrates, for example, a version of the invention in which the primary reflector (2) and the secondary reflector (12) each comprises, respectively, an order 1 transmission surface (11, 21) coaxial, respectively, with the primary reflector (2) and the secondary reflector (12), as well as an order 2 transmission surface (22, 32) inclined in relation to the optical axis A, to transmit the images that pass through the respective vertices (6, 16) to the image capture device (4). The order 1 transmission surfaces (11, 21) and the order 2 transmission surfaces (22, 32) are not necessarily flat. They can have a calculated or selected deformation.

FIG. 9 illustrates, in turn, a version of the invention in which the primary reflector (2) and the secondary reflector (12) are positioned face to face and the image capture device (4) is placed between them. The primary reflector (2) and the secondary reflector (12) in this case each comprise, respectively, a transmission surface (11, 21) inclined in relation to the optical axis A, to transmit images to the image capture device (4). The transmission surfaces (11, 21) are not necessarily flat. They can have a calculated or selected deformation.

The reflector (2, 12) is (are) preferably located in a protective housing (7, 17) having at least one window (8, 18) at least partially transparent over at least the entire height of the concave conical surface (3, 13). The lenses (101, 111) are located in the windows (8, 18). This or these windows (8, 18) form input apertures.

The protective housing (7, 17), moreover, comprises means to enable its attachment to the image capture device (4) in a lighttight manner. These attachment means are, e.g., constituted by screw threads.

In the version illustrated in FIG. 8, the order 1 transmission surfaces (11, 21) are positioned at the bottom of the housings (7, 17) and the order 2 transmission surfaces are positioned in another housing (23) interlocked with the housings (7, 17) and which can be interlocked with the image capture device (4).

In the version illustrated in FIG. 9, the transmission surfaces (11, 21) are positioned in a housing (23) interlocked with the housings (7, 17) and which can be interlocked with the image capture device (4).

The visual fields (5, 15), respectively, of the primary reflector (2) and the secondary reflector (12) are not identical in the different versions. The choice among the different versions is made as a function of the desired visual fields.

The invention also pertains to a set of magnifying devices (100) according to the invention, the magnifying devices (100) having substantially identical general configurations such that they are interchangeable with each other and of different positive and negative enlargements.

The invention also pertains to a panoramic anamorphic image capture system (1) comprising at least one enlargement device according to the invention. The invention further pertains to a panoramic anamorphic image capture process by means of an enlargement device (100) according to the invention.

The capture process enables construction of a digital image by acquisition of a panoramic anamorphic image by means of a system (1) and by digital processing of said image.

The invention is described above as a non-limiting example. It is clear that one of ordinary skill in the art can implement different variants of the invention without departing from the scope of the invention as defined in the appended claims.

1. An enlargement device for a panoramic anamorphic image capture system, said system having an optical axis A as well as a primary reflector means provided with an at least partially reflective exterior primary capture surface, characterized in that it comprises at least one lens in the form of at least a portion of a hollow tube presenting a principal axis P and a positive or negative enlargement essentially perpendicular to this axis.

2. The device according to claim 1, characterized in that the principal axis P is coincident with the optical axis A of the panoramic anamorphic image capture system.

3. The device according to claim 1, characterized in that said lens has the form of a complete hollow tube.

4. The device according to claim 1, characterized in that said lens is mounted so that it can move along its principal axis P.

5. The device according to claim 1, characterized in that said lens has an exterior surface created by means of an essentially parabolic generatrix, a generatrix comprising essentially an arc of a circle or by an essentially elliptic or aspheric generatrix.

6. The device according to claim 1, characterized in that said primary reflector means is constituted by a concave conical primary surface.

7. The device according to claim 1, characterized in that said capture system comprises at least one at least partially reflective transmission surface.

8. The device according to claim 7, characterized in that said capture system comprises a secondary reflector means provided with an at least partially reflective exterior secondary surface having a concave conical form and essentially coaxial with the primary reflector means.

9. The device according to claim 1, characterized in that said lens(es) is (are) located in a protective housing presenting at least one window.

10. A set of enlargement devices according to claim 1, characterized in that said enlargement devices have identical general configurations such that they are interchangeable with each other and of different enlargements.

11. A panoramic anamorphic image capture system comprising at least one enlargement device according to claim 1.

12. A process for capturing panoramic anamorphic images by means of an enlargement device according to claim 1.

13. A magnifying device for a panoramic anamorphic image capture system, the system having an optical axis A and a primary reflector provided with an at least partially reflective exterior primary capture surface, comprising:
at least one lens, at least a portion of which is a hollow tube,
a principal axis P, and
a positive or negative enlargement essentially perpendicular to principal axis P.

14. The device according to claim 13, wherein the principal axis P is coincident with the optical axis A.

15. The device according to claim 13, wherein the lens is a complete hollow tube.

16. The device according to claim 13, wherein the lens is movable along principal axis P.

17. The device according to claim 13, wherein the lens has an exterior surface created by an essentially parabolic generatrix, a generatrix comprising substantially an arc of a circle or by a substantially elliptic or aspheric generatrix.

18. The device according to claim 13, wherein the primary reflector is a concave conical primary surface.

19. The device according to claim 13, wherein the capture system comprises at least one at least partially reflective transmission surface.

20. The device according to claim 19, wherein the capture system comprises a secondary reflector provided with an at least partially reflective exterior secondary surface having a concave conical form and is essentially coaxial with the primary reflector.

21. The device according to claim 13, wherein the lens(es) is (are) located in a protective housing having at least one window.

22. A set of magnifying devices according to claim 13, wherein the enlargement devices have substantially identical configurations such that they are interchangeable with each other and with other magnifying devices.

23. A panoramic anamorphic image capture system comprising at least one magnifying device according to claim 13.
